(19) United States
(12) Patent Application Publication
(10) Pub. No.: US 2010/0216928 A1
(43) Pub. Date: Aug. 26, 2010

(54) POLYMER PARTICLE COMPOSITE HAVING HIGH FIDELITY ORDER, SIZE, AND SHAPE PARTICLES

(75) Inventors: Joseph M. DeSimone, Chapel Hill, NC (US); Robert Lyon Henn, Wilmington, DE (US); Janine Nunes, Chapel Hill, NC (US); Libin Du, Chapel Hill, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignees: The University of North Carolona at Chapel Hill, Chapel Hill, NC (US); Liquidia Technologies, Inc., Research Triangle Park, NC (US)

(21) Appl. No.: 12/514,484

(22) PCT Filed: Nov. 15, 2007
(86) PCT No.: PCT/US07/23805

§ 371 Date: Apr. 30, 2010

Related U.S. Application Data
(60) Provisional application No. 60/859,155, filed on Nov. 15, 2006.

(51) Int. Cl. C08K 3/18

(52) U.S. Cl. 524/413; 524/612

(57) ABSTRACT

A polymer composite includes a polymer and an additive encased in the polymer, wherein the additive includes a plurality of isolated particles where each particle of the plurality of particles has a substantially predetermined three dimensional shape and is substantially oriented with respect to each other in a predetermined two dimensional array.

### CROSS REFERENCE TO RELATED APPLICATION(S)

This application is based off and claims priority to U.S. Provisional Patent Application No. 60/859,155, filed Nov. 15, 2006, which is incorporated herein by reference in its entirety.

### GOVERNMENT INTEREST

A portion of the disclosure contained herein was made with U.S. Government support from the National Science Foundation under Agreement No. CHE 9876674, accordingly, the U.S. Government has certain rights to that portion of the disclosure.

### TECHNICAL FIELD OF THE INVENTION

The present invention generally relates to composite polymer materials. More particularly, the composite polymer materials include discrete particles fabricated with precise size and shape characteristics and control over the orientation of the particles within an array.

### BACKGROUND OF THE FIELD OF THE INVENTION

Growth in the electronics industry has generated a need for the development of new polymer composite materials. Preferably the polymer composite materials would have a high dielectric constant, such as those intrinsic to ferroelectric ceramic materials, yet include the easy processing characteristic of polymers and high dielectric strength of polymers.

Generally in the art, in order to increase the dielectric constant of polymers, ceramic powders with high dielectric constant are added to the polymers. However, the dielectric constant of such systems typically remains low because of the lack of control over parameters such as distribution, size, shape, orientation, placement, and the like of the high dielectric constant additive. Furthermore, due to the lack of control over the size, shape, distribution, orientation, placement, etc., of the powder particles within the polymer, properties such as optical, electric, magnetic, and mechanical cannot be controlled within acceptable tolerances.

Some typical methods used in the art for fabricating high dielectric constant polymer composites include: self-assembly techniques utilizing the interplay between surface energy, dispersion forces, and entropy as further described in Krishnan, R. S., et al., “Self-Assembled Multilayers of Nanocomponents,” Nano Lett. 2007, 7, 484-489; block-copolymer morphologies as further described in Sides, S. W., et al., “Hybrid Particle-Field Simulations of Polymer Nanocomposites,” Phys. Rev. Lett. 2006, 96, 250601; and directing patterning with a spatially varying field, such as mechanical deformation, an electric field, a magnetic field, or an optical field and as further described in Koener, H., “Generating Triaxial Reinforced Epoxy/Montmorillonite Nanocomposites with Uniaxial Magnetic Fields,” Chem. Mater. 2005, 17, 1990-1996; each of which is hereby incorporated in its entirety. However, each of these techniques has drawbacks related to the additive, such as, lack to control over the shape of the additive, size of the additive, two-dimensional and three-dimensional orientation of the additives, non-aggregation of the additives, and the like.

Some prior art examples of dispersing nano or micro particles into a polymer include 1) a method in which nanometer-sized metal particles and semiconductor particles are produced by sputtering, CVD, or another vapor phase method, and the surroundings thereof are covered with an inert substance to form a deposited film on a substrate (e.g., Japanese Laid-Open Patent Application H10-292065); 2) a method in which nanoparticles are dispersed and compounded in the liquid phase in a sol-gel compound (Japanese Laid-Open Patent Application H8-245263); 3) a method in which a semiconductor component is dispersed in a polymer, after which another component is diffused into this, and this product is irradiated with a laser to form nanoparticles (Japanese Laid-Open Patent Application H10-36517); 4) a method in which various types of nanoparticles are deposited on a polymer resin in a thermodynamically unstable state, after which this is heated to change the polymer into a thermally stable state and diffuse the nanoparticles into the polymer (Japanese Laid-Open Patent Application H6-157771); 5) U.S. Pat. No. 6,416,855, a dissolved resin suspending method for preparing resin particles which includes dissolving a resin in a solvent in advance, dispersing the resin solution in an aqueous medium in the presence of a surfactant or a dispersant (auxiliary dispersant), such as a water-soluble polymer, and removing the solvent by heating or pressure reduction (examined Japanese Patent Publication No. 28688/1986, unexamined Japanese Patent Publication No. 25664/1988); 6) a method to dispersing the nano-sized material within the molten material using at least one dispersion technique selected from the group of agitating the molten material using ultrasonic energy U.S. Pat. No. 6,939,388; 7) a method of treating the surface of the particle to form covalent, ionic, hydrogen or other van der waals interactions with the matrix has also been reported; 8) a method of adding a surfactant molecule, or covalently bonding a surfactant-like molecule to the matrix or particle has also been used to cause dispersion; and 9) methods using various additives such as surfactants, thickeners and the like are used to prevent the fine resin particles from gathering or precipitating and to have them stably dispersed in the water (for example, see Japanese Patent Laid-Open No. 2001-220544 and Japanese Patent Laid-Open No. 7-196953 (1995); each of which are incorporated herein by reference in their entirety.

Other existing technologies include those described in U.S. Pat. No. 4,335,180, which discloses a polymer-ceramic composite having an anionic dispersion of poly(tetrafluoroethylene) where the particulate filler is titania and further includes microfibrous material comprising glass microfibers. The dielectric constants of these polymer composites were measured to be 10-11. Another prior art device is described in U.S. Pat. No. 5,358,775, which discloses a polmer ceramic composite having a fluoropolymer (poly(tetrafluoroethylene)) filled with a particulate ceramic material which exhibits low loss, high dielectric constant and an acceptable low thermal coefficient of dielectric constant.

However, each of these devices suffers similar drawbacks to other prior art devices in that the size, shape, and arrangement of the additive fillers cannot be precisely controlled.

A discrete nano or micro particle fabrication technique referred to as Particle Replication in Nonwetting Templates, or PRINT™, (Liquidia Technologies, North Carolina) has recently been disclosed in Rolland, J. P.; Maynor, B. W.; Euliss, L. E.; Exner, A. E.; Denison, G. M.; DeSimone, J. M. “Direct Fabrication and Harvesting of Monodisperse, Shape-Specific Nanobiomaterials” J. Am. Chem. Soc. 2005, 127, 10096-10100, which is incorporated herein by reference in its entirety. Utilizing this technique to fabricate polymer composites can overcome drawbacks of the prior art by providing tunability of additive, or filler, particle parameters such as shape, size, aspect ratio, orientation, composition, and the like.

### SUMMARY OF THE INVENTION

A polymer composite is provided by the present invention that includes a polymer and an additive encased in the polymer, wherein the additive includes a plurality of isolated particles and each particle of the plurality of particles has a substantially predetermined three dimensional shape and is substantially oriented with respect to each other in a predetermined two dimensional array. In some embodiments, the polymer encasing the additive can be configured into a film or thin layer.

In some embodiments, a second polymer film encasing a second additive can be coupled with the first film. Prior to coupling, the second polymer film can be registered with the first film to position the additive in the second polymer film in a predetermined orientation with respect to the additive in the first film. Alternatively, prior to coupling the second polymer film can be registered with the first film to align the additive in the second polymer film with the additive in the first film. The second polymer film can also be registered with the first film to position the additive in the second polymer film with respect to the additive in the first film to manipulate light.

In alternative embodiments, the polymer composite film of the present invention has a thickness of less than about 20 micrometers, less than about 10 micrometers, less than about 1 micrometer, or less than about 500 nanometers. In some embodiments, a multi-layered device can be fabricated by coupling multiple polymer composite layers with respect to each other and in some embodiments the layers can be the same thickness, different thicknesses, include the same composition, have different compositions, have additives of the same size and/or shape, include additives of different sizes and/or shapes, include the additive arranged in the same or different array formats, include the same or different polymer materials, combinations thereof, or the like.

In alternative embodiments, the additives can include a substantially predetermined shape having a broadest cross-sectional dimension less than about 5 micrometers, less than about 1 micrometer, less than about 0.5 micrometers, less than about 0.25 micrometers, less than about 0.1 micrometers, or dimensions therebetween.

In some embodiments, the predetermined two dimensional array of particles includes an array having a spacing between adjacent particles substantially equivalent to a diameter of the particles. In other embodiments, the predetermined two dimensional array of particles includes an array of particles having a spacing between adjacent particles less than about a diameter of a particle of the array of particles. Preferably each particle of the plurality of particles is not aggregated with other particles of the plurality of particles. In some embodiments, the polymer composite can include additives of different materials, different particle sizes, different particle shapes, and the like. In some embodiments, the polymer composite includes a perfluoropolyether.

The polymer composite of the present invention includes a dielectric strength of less than about 100 kV/mm or a dielectric strength of between about 5 kV/mm and about 100 kV/mm. In alternative embodiments, the polymer composite has a dielectric strength greater than about 8 kV/mm, greater than about 12 kV/mm, or greater than about 20 kV/mm. In alternative embodiments, the polymer composite includes a volume fraction of additive of between about 0.1 percent and about 75 percent or a volume fraction of additive of between about 0.1 percent and about 50 percent.

The polymer composite of the present invention can be utilized as an energy storage device, as an optical device, as a photonic band gap device, as a waveguide, as a sensor, a biomimetic, or an actuator.

A method for making a polymer composite of the present invention includes molding isolated particles in cavities of a low surface energy polymeric material, harvesting the isolated particles from the cavities of the low surface energy polymeric material into an array of isolated particles, and filling space between the harvested isolated particles with a polymer material such that the isolated particles are encased within the polymer material. In some embodiments, the low surface energy polymeric material is a perfluoropolyether. In some embodiments, harvesting of the particles includes removing the isolated particles from the cavities or dissolving the low surface energy polymeric material. In some embodiments, the polymer material encasing the isolated particle includes a perfluoropolyether. In some embodiments, after harvesting of the particles, the harvested isolated particles are treated. In some embodiments, after the filling of the space between the particles, a second layer of polymer composite material encasing harvested isolated particles can be coupled to the polymer material encasing the harvested isolated particles. In some embodiments, before multiple layers of polymer composite are coupled together they are registered to position the additives in a predetermined orientation.

### BRIEF DESCRIPTION OF THE FIGURES

FIG. 1 shows a schematic of a process for fabricating a polymer composite film according to an embodiment of the present invention; and

FIG. 2 shows SEM images of a cross-section of a six-layer composite according to an embodiment of the present invention having 3 micrometer additive particles uniformly throughout a continuous phase.

### DETAILED DESCRIPTION OF EMBODIMENTS OF THE INVENTION

### Definitions

The term “composite” means a multicomponent material having multiple different (nongaseous) phase domains in which at least one type of phase domain is a continuous phase.

The term “polymer composite” means a composite in which at least one component is a polymer.

The term “nanocomposite” means a composite in which at least one of the phases has at least one dimension of the order of nanometers.

The term “additive” means a substance added to a polymer. For example, an additive is usually a minor component of the mixture formed and usually modifies the properties of the polymer.

The term “phase domain” means a region of a material that is uniform in chemical composition and physical state. A phase in a multiphase material can form domains differing in size and the term “domain” may be qualified by the prefix micro or nano according to the size of a linear dimension of the domain.

The term “continuous phase domain” means a phase domain having a single phase in a heterogeneous mixture through which a continuous path to all phase domain boundaries may be drawn without crossing a phase domain boundary.

The term “discontinuous phase domain” means a phase domain in a phase-separated mixture that is surrounded by a continuous phase but isolated from all other similar phase domains within the mixture.

The present invention generally utilizes the PRINT™ techniques, materials, methods, and the like (Liquidia Technologies, Inc., North Carolina) disclosed and taught in U.S. Provisional Patent Application Ser. No. 60/691,607, filed Jun. 17, 2005; U.S. Provisional Patent Application Ser. No. 60/714,961, filed Sep. 7, 2005; U.S. Provisional Patent Application Ser. No. 60/734,228, filed Nov. 7, 2005; U.S. Provisional Patent Application Ser. No. 60/762,802, filed Jan. 27, 2006; U.S. Provisional Patent Application Ser. No. 60/799,876 filed May 12, 2006; WO 07/024,323 (PCT International Application Serial No. PCT/US06/23722), filed Jun. 19, 2006; U.S. Provisional Patent Application Ser. No. 60/798,858, filed May 9, 2006; U.S. Provisional Patent Application Ser. No. 60/799,876, filed May 12, 2006; U.S. Provisional Patent Application Ser. No. 60/800,478, filed May 15, 2006; U.S. Provisional Patent Application Ser. No. 60/811,136, filed Jun. 5, 2006; U.S. Provisional Patent Application Ser. No. 60/817,231, filed Jun. 27, 2006; U.S. Provisional Patent Application Ser. No. 60/831,372, filed Jul. 17, 2006; U.S. Provisional Patent Application Ser. No. 60/833,736, filed Jul. 27, 2006; WO 07/030,698 (PCT International Patent Application Serial No. PCT/US06/034997), filed Sep. 7, 2006); WO 05/01466 (PCT International Patent Application Serial No. PCT/US04/42706), filed Dec. 20, 2004, which is based on and claims priority to U.S. Provisional Patent Application Ser. No. 60/531,531, filed Dec. 19, 2003, U.S. Provisional Patent Application Ser. No. 60/583,170, filed Jun. 25, 2004, United States Provisional Patent Application Ser. No. 60/604,970, filed Aug. 27, 2004, PCT International Patent Application Serial No. PCT/US06/34997; PCT International Patent Application Serial No. PCT/US06/043305; PCT International Patent Application Serial No. PCT/U.S.07/002,476; PCT International Patent Application Serial No. PCT/U.S.07/011,220; PCT International Patent Application Serial No. PCT/U.S.07/011,752; and PCT International Patent Application Serial No. PCT/U.S.07/16248; and Rolland J., et al. “Direct Fabrication and Harvesting of Monodisperse, Shape-Specific Nanobiomaterials” J. Am. Chem. Soc. 2005, 127, 10096-10100; each of which are incorporated herein by reference in their entirety, to fabricate nano and/or micro structures used in the present invention.

The techniques, methods, materials, and the like utilized in the present invention will now be generally described, however, for further detail see the references incorporated-by-reference herein in their entirety above. Generally, a low-surface energy fluoropolymer mold is formed by casting a liquid fluoropolymer, such as a perfluoropolyether or FLUOROCUR™ (Liquidia Technologies, Inc., North Carolina) onto a master that includes precise nano and/or micro structures formed from a lithography process. The liquid fluoropolymer is particularly suited to wet the surface of the master and configured to minimally or substantially not change volume upon curing into a solid.

Next, after the liquid fluoropolymer has wetted the structured surface of the master, the liquid fluoropolymer is cured by such mechanisms as the application of actinic radiation, light energy, photocuring, thermal energy, combinations thereof, or the like and the cured fluoropolymer mold is then removed from the master. Because the fluoropolymer has a very low surface energy, the cured replica is removable from the master intact. Also, because the fluoropolymer substantially does not change volume between its liquid and solid states, the precisely engineered structures of the master are substantially mimicked precisely as cavities in the cured fluoropolymer mold. Furthermore, due to the low surface energy of the fluoropolymer, the cured fluoropolymer mold can be used to fabricate structures, such as micro and/or nano particles within the cavities of the fluoropolymer mold. A suitable pre-particle material, such as a ceramic or ceramic in a sol-gel formulation may be added to the mold cavities and cured to fabricate structures, such as isolated micro and/or nano particles. Therefore, isolated micro and/or nano particles can be fabricated within the cavities that have engineered high fidelity sizes and shapes mimicking the shape and size of the cavities of the mold. As a result, isolated micro and/or nano particles may be fabricated in a substantially predetermined shape. In some embodiments, micro and/or nano particles are fabricated with substantially monodisperse size and/or shape. According to other embodiments, the particles produced by the methods and materials of the presently disclosed subject matter have a poly dispersion index (i.e., normalized size distribution) of between about 0.80 and about 1.20, between about 0.90 and about 1.10, between about 0.95 and about 1.05, between about 0.99 and about 1.01, between about 0.999 and about 1.001, combinations thereof, and the like. Furthermore, in other embodiments the particle has a mono-dispersity. According to some embodiments, dispersity is calculated by averaging a dimension of the particles. In some embodiments, the dispersity is based on, for example, surface area, length, width, height, mass, volume, porosity, combinations thereof, and the like.

Next, the isolated particles within the cavities of the fluoropolymer mold can be removed from the cavities, or harvested, onto a substrate. Because the fluoropolymer has a low surface energy, the particles within the cavities have greater affinity for a substrate or a treated surface than they have for the mold material and, therefore, remove from the mold upon encountering such a substrate or treated surface. Furthermore, upon removal or harvesting, the isolated particles remain isolated and positioned within a two-dimensional array that substantially mimics the array of cavities of the mold. As a result, a plurality of particles may be fabricated and harvested such that each particle of the plurality of particles is substantially oriented with respect to each other in a predetermined two dimensional array. This type of two-dimensional array can be engineered to meet the needs of an article of manufacture based on the design of the structure built into the master. Therefore, the density of particles, position of the particle with respect to the substrate or treated surface, spacing between adjacent particles, relationship of particles to each other within the array, combinations thereof, and the like can be tailored for an intended purpose. In some embodiments, orientation of a particle may be based on an angle between a chosen axis of the particle and the surface. For example, a chosen axis of each particle may be oriented parallel to the surface. In other embodiments, a chosen axis of each particle may be oriented perpendicular to the surface.

Using the replication approach of the present invention offers control of a wide range of additive or filler and particle parameters such as shape, size, aspect ratio, orientation, and composition. Furthermore, through the repetitive use of the PRINT™ technique, multiple articles can be fabricated that can thereafter be coupled together to form a layered device with control over each individual feature of each individual layer. Moreover, the layers can be registered when coupled together to generate a three-dimensional device with control over the two-dimensional organization of materials within each respective layer, as well as the three-dimensional interlayer arrangement between adjacent layers. Therefore, layer by layer assembly of polymer, polymer composite, polymer composites with inorganic particles, or inorganic particle structure architectures can be fabricated. Importantly, the particles fabricated with these techniques do not percolate or aggregate.

Utilizing the above described replication techniques, materials, and methods, as well as, the incorporated by reference U.S. and International patent applications, it is possible to engineer polymer composites that exhibit advantageous electrical, optical, mechanical, or the like properties.

According to certain embodiments of the present invention, low volume fraction multilayered composites of micrometer cylindrical particles can be fabricated as set forth herein. According to an embodiment of the present invention, a low volume fraction multilayered composite is fabricated with isolated 3 micrometer cylindrical barium titanate particles dispersed in a controlled array in PFPE. According to another embodiment of the present invention, a low volume fraction multilayered composite is fabricated with isolated 3 micrometer cylindrical cadmium oxide particles dispersed in a controlled array in PFPE. According to these embodiments, the low volume fraction is between about 1 percent and about 10 percent of the volume of the polymer composite.

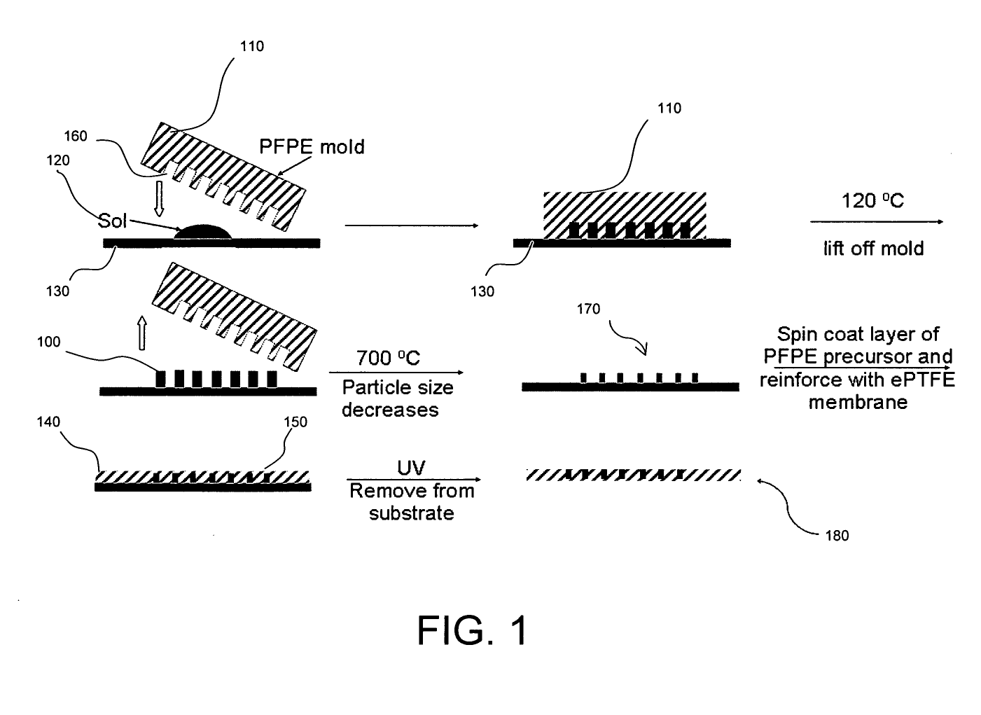

Referring to FIG. 1, in certain embodiments, in a first step in the composite fabrication, a scum free isolated particle array 170 is prepared on substrate 130. In one embodiment, to generate particles 100, a liquid precursor, or sol-gel 120, was used to have the pre-particle material enter cavities 160 of mold 110. The preparation of sol-gel 120 is a common technique in the art as will be appreciated by one of ordinary skill in the art and, therefore, will not be further described herein. Next, a drop of sol 120 may be placed on surface 130 and PFPE based mold 110 having predetermined micrometer sized cylindrical cavities 160. In some embodiments, pressure can be applied to remove residual air and assist pre-particle materials 120 to enter cavities 160. In some embodiments, the pressure can be applied for a time, of about an hour for example, and/or under treating conditions, such as for example, heating or the like. In some embodiments, mold 110 can then be removed leaving array 170 of micrometer cylindrical xerogel particles 100 on surface 130. In some embodiments, array 170 of particles 100 can then be further processed, such as by placing it in a furnace to anneal particles 100. In some embodiments, particles 100 decrease in size during the annealing process.

In some embodiments, in a next step in the fabrication of a composite of the present invention, first reinforced composite layer 180 is prepared. In some embodiments, a polymer precursor is applied, by spin-coating for example, onto particle array 170 to encase particles 100 in polymer 140. In certain embodiments, backing layer 150, such as an expanded polytetrafluoroethylene (ePTFE) membrane can be placed on the layer of polymer 140, which is applied over and around array 170 of particles 100. According to some embodiments, a curing step can be applied to the polymer 140/backing 150/particle 100 combination to cure polymer 140 and bind it with backing 150. In some embodiments, the curing can be a photocuring, photocuring in nitrogen, thermal curing, or the like. In certain embodiments, the composite layer can then be removed from surface 130 to yield first film 180 of polymer composite having isolated micro or nano particles 100 dispersed therein in ordered array 170.

According to alternative embodiments, high volume fraction multilayered composites can be fabricated by optimizing such parameters as modifying sol-gel chemistry of the additive component prior to introducing it to the mold cavities to reduce shrinking, such as during an annealing phase, minimizing the polymer thickness of each layer, using masters with high density features, combinations thereof, and the like. According to some embodiments, high volume fraction of the additive particles includes between about 25 percent to about 75 percent. In alternative embodiments, high volume fraction of the additive particles includes between about 20 percent to about 50 percent. In still further embodiments, high volume fraction of the additive particles includes between about 40 percent to about 50 percent.

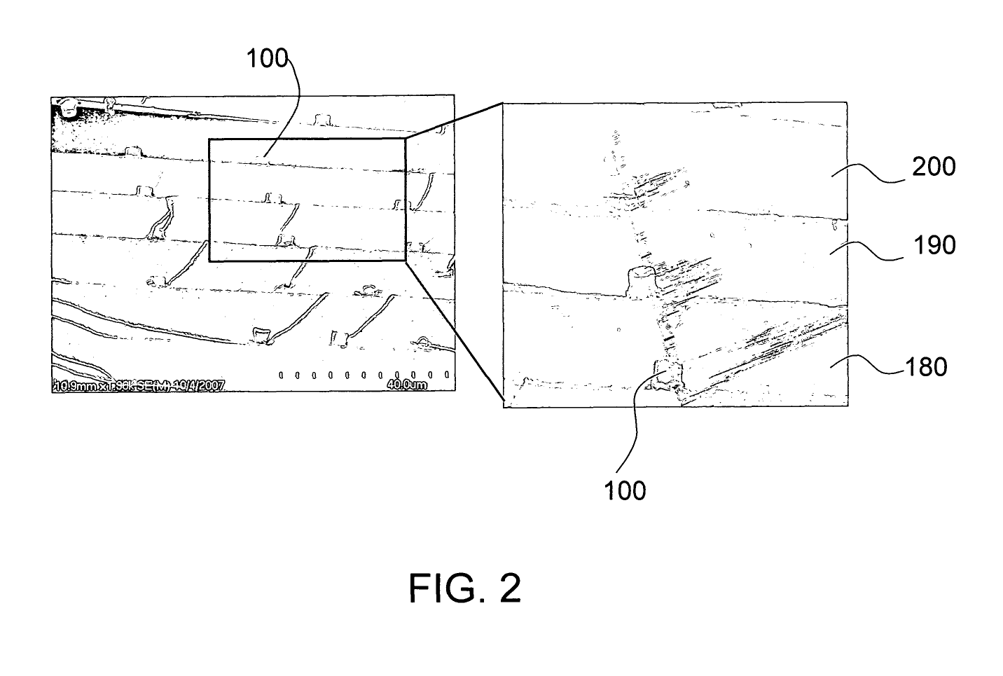

Referring now to FIG. 2, additional layers can be added to first film layer 180 as described above. Additional layers can be formed by introducing particle pre-cursor material 120 to cavities 160 of PFPE mold 110 and forming particles 100 therein. Next, particles 100 can be harvested onto surface 130 and annealed. Following annealing, the particles can be encased in polymer 140, such as PFPE or the like and polymer 140 can be hardened or cured. Following hardening, second layer or film of composite polymer 190 can be coupled with the first film of polymer composite 180. In some embodiments, coupling of layers 180, 190, 200 can be achieved by thermally treating multiple layers 180, 190, 200 or applying actinic radiation to multiple layers 180, 190, 200.

In some embodiments, the second polymer composite layer can be registered with the first film of polymer composite to align the particle additives. In another embodiment, the second polymer composite layer can be registered with the first film of polymer composite to arrange the additive particles into a desired three dimensional orientation. In some embodiments, the additives can be organized in arrayed patterns and/or registered with respect to adjacent composite film layers to manipulate light.

In some embodiments a second polymer composite layer can include a second additive. In some embodiments, the second additive can be fabricated from different material from the additive of the first composite film, fabricated into a different shape from the shape of the additive in the first film, fabricated into a different size from the size of the additive in the first film, arranged in a different arrayed pattern than the additives in the first film, oriented differently with respect to each other than the additives in the first film, combinations thereof, or the like. In some embodiments, a multi-layered device can be fabricated by coupling multiple polymer composite layers with respect to each other and in some embodiments the layers can be the same thickness, different thicknesses, include the same composition, have different compositions, have additives of the same size and/or shape, include additives of different sizes and/or shapes, include the additive arranged in the same or different array formats, include the same or different polymer materials, combinations thereof, or the like.

In some embodiments, composites can be fabricated where each layer has a different functionality, volume fraction, shape of additive particle, size of additive particle, orientation of additive particle, additive particles organized in different array formats, additive particles fabricated from different types of materials, combinations thereof, and the like to thereby create hierarchically or complex structured multifunctional composite materials.

Structural property relationships of the particle additives can be selected and engineered on such parameters as particle shape, particle size, volume fraction, porosity, charge, aspect ratio of the particles, combinations thereof, and the like.

In some embodiments, the composite film layers can be less than about 50 micrometers thick. In some embodiments, the composite film layers can be less than about 30 micrometers thick. In some embodiments, the composite film layers can be less than about 20 micrometers thick. In some embodiments, the composite film layers can be less than about 10 micrometers thick. In some embodiments, the composite film layers can be less than about 5 micrometers thick. In some embodiments, the composite film layers can be less than about 1 micrometer thick. In some embodiments, the composite film layers can be less than about 0.750 micrometers thick. In some embodiments, the composite film layers can be less than about 0.500 micrometers thick. In some embodiments, the composite film layers can be less than about 0.250 micrometers thick. In some embodiments, the composite film layers can be less than about 0.200 micrometers thick. In some embodiments, the composite film layers can be less than about 0.100 micrometers thick. In some embodiments, the composite film layers can be less than about 0.050 micrometers thick.

In alternative embodiments, the additive particle of the composite polymer can have a broadest cross-sectional dimension of less than about 25 micrometers. In alternative embodiments, the additive particle of the composite polymer can have a broadest cross-sectional dimension of less than about 20 micrometers. In alternative embodiments, the additive particle of the composite polymer can have a broadest cross-sectional dimension of less than about 15 micrometers. In alternative embodiments, the additive particle of the composite polymer can have a broadest cross-sectional dimension of less than about 10 micrometers. In alternative embodiments, the additive particle of the composite polymer can have a broadest cross-sectional dimension of less than about 9 micrometers. In alternative embodiments, the additive particle of the composite polymer can have a broadest cross-sectional dimension of less than about 8 micrometers. In alternative embodiments, the additive particle of the composite polymer can have a broadest cross-sectional dimension of less than about 7 micrometers. In alternative embodiments, the additive particle of the composite polymer can have a broadest cross-sectional dimension of less than about 6 micrometers. In alternative embodiments, the additive particle of the composite polymer can have a broadest cross-sectional dimension of less than about 5 micrometers. In alternative embodiments, the additive particle of the composite polymer can have a broadest cross-sectional dimension of less than about 4 micrometers. In alternative embodiments, the additive particle of the composite polymer can have a broadest cross-sectional dimension of less than about 3 micrometers. In alternative embodiments, the additive particle of the composite polymer can have a broadest cross-sectional dimension of less than about 2 micrometers. In alternative embodiments, the additive particle of the composite polymer can have a broadest cross-sectional dimension of less than about 1 micrometer. In alternative embodiments, the additive particle of the composite polymer can have a broadest cross-sectional dimension of less than about 0.75 micrometers. In alternative embodiments, the additive particle of the composite polymer can have a broadest cross-sectional dimension of less than about 0.70 micrometers. In alternative embodiments, the additive particle of the composite polymer can have a broadest cross-sectional dimension of less than about 0.65 micrometers. In alternative embodiments, the additive particle of the composite polymer can have a broadest cross-sectional dimension of less than about 0.60 micrometers. In alternative embodiments, the additive particle of the composite polymer can have a broadest cross-sectional dimension of less than about 0.55 micrometers. In alternative embodiments, the additive particle of the composite polymer can have a broadest cross-sectional dimension of less than about 0.50 micrometers. In alternative embodiments, the additive particle of the composite polymer can have a broadest cross-sectional dimension of less than about 0.45 micrometers. In alternative embodiments, the additive particle of the composite polymer can have a broadest cross-sectional dimension of less than about 0.40 micrometers. In alternative embodiments, the additive particle of the composite polymer can have a broadest cross-sectional dimension of less than about 0.35 micrometers. In alternative embodiments, the additive particle of the composite polymer can have a broadest cross-sectional dimension of less than about 0.30 micrometers. In alternative embodiments, the additive particle of the composite polymer can have a broadest cross-sectional dimension of less than about 0.25 micrometers. In alternative embodiments, the additive particle of the composite polymer can have a broadest cross-sectional dimension of less than about 0.20 micrometers. In alternative embodiments, the additive particle of the composite polymer can have a broadest cross-sectional dimension of less than about 0.15 micrometers. In alternative embodiments, the additive particle of the composite polymer can have a broadest cross-sectional dimension of less than about 0.10 micrometers. In alternative embodiments, the additive particle of the composite polymer can have a broadest cross-sectional dimension of less than about 50 nanometers. In alternative embodiments, the additive particle of the composite polymer can have a broadest cross-sectional dimension of less than about 45 nanometers. In alternative embodiments, the additive particle of the composite polymer can have a broadest cross-sectional dimension of less than about 40 nanometers. In alternative embodiments, the additive particle of the composite polymer can have a broadest cross-sectional dimension of less than about 35 nanometers. In alternative embodiments, the additive particle of the composite polymer can have a broadest cross-sectional dimension of less than about 30 nanometers. In alternative embodiments, the additive particle of the composite polymer can have a broadest cross-sectional dimension of less than about 25 nanometers. In alternative embodiments, the additive particle of the composite polymer can have a broadest cross-sectional dimension of less than about 20 nanometers. In alternative embodiments, the additive particle of the composite polymer can have a broadest cross-sectional dimension of less than about 15 nanometers. In alternative embodiments, the additive particle of the composite polymer can have a broadest cross-sectional dimension of less than about 10 nanometers. In alternative embodiments, the additive particle of the composite polymer can have a broadest cross-sectional dimension of less than about 9 nanometers. In alternative embodiments, the additive particle of the composite polymer can have a broadest cross-sectional dimension of less than about 8 nanometers. In alternative embodiments, the additive particle of the composite polymer can have a broadest cross-sectional dimension of less than about 7 nanometers. In alternative embodiments, the additive particle of the composite polymer can have a broadest cross-sectional dimension of less than about 6 nanometers. In alternative embodiments, the additive particle of the composite polymer can have a broadest cross-sectional dimension of less than about 5 nanometers. In alternative embodiments, the additive particle of the composite polymer can have a broadest cross-sectional dimension of less than about 4 nanometers. In alternative embodiments, the additive particle of the composite polymer can have a broadest cross-sectional dimension of less than about 3 nanometers. In alternative embodiments, the additive particle of the composite polymer can have a broadest cross-sectional dimension of less than about 2 nanometers. In alternative embodiments, the additive particle of the composite polymer can have a broadest cross-sectional dimension of less than about 1 nanometer.

In some embodiments, the predetermined two dimensional array of particles includes an array having a spacing between adjacent particles substantially equivalent to a diameter of a single particle, less than about a diameter of a single particle of the array of particles, greater than about a diameter of a single particle of the array of particles, or the like. In some embodiments, the volume fraction of particles in the composite material is about 50 percent. In other embodiments, the volume fraction of particles in the composite material is between about 20 percent and about 50 percent. In yet other embodiments, the volume fraction of particles in the composite includes between about 0.1 percent and about 75 percent.

In some embodiments, the polymer composite has a dielectric strength of greater than about 100 kV/mm. In some embodiments, the polymer composite has a dielectric strength of less than about 100 kV/mm. In alternative embodiments, the polymer composite has a dielectric strength of less than about 95 kV/mm, of less than about 90 kV/mm, of less than about 85 kV/mm, of less than about 80 kV/mm, of less than about 75 kV/mm, of less than about 70 kV/mm, of less than about 65 kV/mm, of less than about 60 kV/mm, of less than about 55 kV/mm, less than about 50 kV/mm, of less than about 45 kV/mm, of less than about 40 kV/mm, of less than about 35 kV/mm, of less than about 30 kV/mm, less than about 25 kV/mm, of less than about 20 kV/mm, less than about 15 kV/mm, of less than about 10 kV/mm, and the like.

In some embodiments, the composite of the present invention is configured and dimensioned as an energy storage device, a supercapacitor, an optical device, a photonic band gap device, a waveguide, a sensor, a biomimetic, an actuator, combinations thereof, or the like. In alternative embodiments, alternative materials for fabricating the additive particles can include, for example, conducting materials, magnetic material, and the like. In alternative embodiments, the particles can be fabricated into poled particles.

Additives of the present invention can include conducting materials. Examples of conducting materials that can be used in the present invention include, but are not limited to, transition metals, alloys of transition metals, carbon black, carbon fiber, graphite, combinations thereof, and the like. In some embodiments, the transition metals can include, but are not limited to, nickel, copper, aluminum, palladium, silver, gold, platinum, tin, lead, combinations of these transition metals, alloys of these transition metals, and the like. Additives of the present invention can also include metal oxides, doped oxides, coated oxides, oxynitrides, nitrides carbides, combinations thereof, and the like. In alternative embodiments, additives of the present invention include, but are not limited to, ceramic materials, oxides, carbides, silica, doped silica, titanate, barium titanate, doped barium titanate, lead magnesium niobate, lead titanate, strontium, other high dielectric constant ceramics, nitrides, chalcogenides, metal acetylacytonate, metal thiocyanamines, other high dielectric constant polymers, combinations thereof, and the like. In alternative embodiments, the polymer composite includes a polymer encasing a carbon nanotube. In some embodiments, the cavities of the mold are configured to form a carbon nanotube or multiple carbon nanotubes therein.

In other embodiments, the additives of the present invention can be hollow, dense, porous, semi-porous, coated, uncoated, layered, laminated, simple, complex, dendritic, inorganic, organic, elemental, non-elemental, composite, doped, undoped, spherical, non-spherical, surface functionalized, surface non-functionalized, stoichiometric, non-stoichiometric form, combinations thereof, and the like. In some embodiments, the additives of the present invention can include, but is not limited to, polymerizable ionic liquids. In some embodiments, the polymerizable ionic liquids can be poled prior to polymerization in the cavities of the mold to make highly anisotropic particles with a permanent asymmetric distribution of cationic and anionic charges within individual particles.

According to some embodiments, suitable base polymers for use in the present invention include, but are not limited to, polymer resins, epoxies, acrylates, polyimides, cyanate esters, thermoplastic polymers, fluoropolymers, polyurethane, polytetrafluoroethylene, polytetrafluoroethylene and glass, perfluoroalkoxy copolymer, fluorinated ethylene propylene resin, ethylene-tetrafluoroethylene, polyvinylidene difluoride, ethylene chlorotrifluoroethlyene, polychlorotrifluoroethylene, polyimides, polyphenylene sulfide, poly(ether sulfones), polyetheretherketones, ultra high molecular weight polyethylene, polycaprolactam, nylon 66, high density polyethylene, acetal, combinations thereof, or the like.

In some embodiments, the polymer of the polymer composite of the present invention can be a thermoset polymer. In some embodiments polymers of the present invention can include, but are not limited to, phenol-formaldehyde, melamine-formaldehyde, urea-formaldehyde, polyurethane, unsaturated polyester, epoxy, phenolic aniline, furan, polyester, polyurethane, polyphenylene sulfide, polyimide, silicone, poly-p-phenylene benzobisthiazole, polyacrylate, polymethacrylate, novolac, phenolic, alkyd, combinations thereof, and the like.

In some embodiments, the polymer of the composite of the present invention can be a thermoplastic. According to alternative embodiments of the present invention, the polymer can include, but is not limited to, a polyethylene, polypropylene, polystyrene, polyvinyl chloride, polyvinyl alcohol, polytetrafluoroethylene, polytetrafluoroethylene-co-ethylene, polymethyl methacrylate, polymethyl methacrylate-co-acrylonitrile, polystyrene, polystyrene/polybutadiene, polystyrene/polybutadiene-co-acrylonitrile, polybutadiene, polystyrene-co-acrylonitrile, polyoxymethylene, polyethylene terephthalate, polycarbonate, poly e-caprolactam, polyhexamethylene adipamide, polysulfone, cellulose acetate, cellulose acetobutyrate, cellulose, polyisoprene, polybutadiene-co-styrene, polybutadiene-co-acrylonitrile, polychloroprene, polyisobutene-co-isoprene, bromo butyl rubber, polyethylene chlorosulfonated, polyethyl acrylate, polyethylene-co-vinyl acetate, polyethylene-co-propylene, polyurethane rubber, polysulfide rubber, silicone rubber, polyvinyl butyrate, polyvinyl fluoride, polyvinylidene fluoride, polyester, polyacetal, polyamide, nitrile, cellulose nitrate, acrylonitrile-butadiene-styrene, polysulphone, polymethylpentene, ethylene/vinyl acetate copolymer, polyoxymethylene, polyethylene oxide, polyimide, ethyl cellulose, cellulose propionate, cellulose acetate butyrate, polyvinyl acetate, styrene-butadiene copolymers, polyvinyl acetate copolymers, polymethyl methacrylate copolymers, combinations thereof, and the like.

According to some embodiments of the present invention, a method for fabricating the composite particles of the present invention includes molding isolated particles in cavities of a low surface energy polymeric material and harvesting the isolated particles from the cavities of the low surface energy polymeric material into an array of isolated particles. In some embodiments, the particles are ceramic. In some embodiments, the method includes filling space between the harvested isolated particles with a polymer material such that the isolated particles are encased within the polymer material. In some embodiments, the low surface energy polymeric material comprises perfluoropolyether. In some embodiments, harvesting includes removing the isolated particles from the cavities or dissolving the low surface energy polymeric material. In some embodiments, the polymer material encasing the isolated particle comprises a perfluoropolyether. According to some embodiments, after harvesting the particles, the harvested particles are treated. According to yet other embodiments, after the particles are encased in the polymer, the polymer composite can be coupled with a second layer of polymer material encasing separately prepared and harvested isolated particles. In yet other embodiments, two or more layers of polymer composite can be registered with respect to each other such that the additive particles are aligned, randomly positioned, or arranged in a manner to manipulate light or provide other characteristics to the polymer composite such as mechanical, chemical, optical, thermal, physical properties or the like.

In some embodiments, micro or nano-structured fillers or additives can be used to lower or raise the effective resistivity, effective permittivity, or effective permeability of a polymer. While these effects may be present at lower loadings, they should be pronounced for additive loadings at or above the percolation limit of the additive in the polymer (i.e., at loadings sufficiently high that electrical continuity exists between the additive micro or nano particles). Other electrical properties that can be engineered into the polymer composite include breakdown voltage, skin depth, curie temperature, temperature coefficient of electrical property, voltage coefficient of electrical property, dissipation factor, work function, band gap, electromagnetic shielding effectiveness, degree of radiation hardness, or the like. In some embodiments, micro or nano-structured additive can also be used to engineer magnetic properties such as the coercivity, B-H product, hysteresis, shape of the B-H curve of a matrix, or the like.

In some embodiments, an important characteristic of optical material includes its refractive index and its transmission and reflective characteristics. According to some embodiments, micro and/or nano-structured additives of the present invention can be used to produce composites with refractive index engineered for a particular application. Likewise, gradient lenses can be produced using the micro and/or nano-structured additive particles of the present invention. Gradient lenses produced from the polymer composites of the present invention can reduce or eliminate the need for polishing lenses. The use of additive particles of the present invention can also help filter specific wavelengths. A further advantage of the polymer composite of the present invention in optical applications is the composite's enhanced transparency due to the controlled size of the additive particles from about the same as to more than an order of magnitude less than the wavelengths of visible light.

In some embodiments, the polymer composite of the present invention can be used in supercapacitors or on-chip all-solid-state thin film supercapacitors for such applications as satellites, microelectronic mechanical systems (MEMS), or the like. Such supercapacitors can also provide a non-Faradaic alternative to on-chip supercapacitors with electrodes made of thin sputter-coated films of metal oxides.

The basic arrangement of components in most supercapacitors includes two active electrodes, interposed by an electrolyte, separated by an insulating porous separator, and sandwiched between two current collectors. Multiple layers of current collector (CC), electrode material (EM) and separator (SP) can be used in different supercapacitor designs to provide a desired power density and/or energy density for particular applications. Examples of multiple-layer constructions based on such a basic arrangement include, but are not limited to, bi-polar stacked design and spiral-wound design. As will be appreciated by one of ordinary skill in the art, the polymer composite of the present invention can be incorporated into such supercapacitor stacks. The capacitance of the polymer composite supercapacitor of the present invention can be evaluated by methods, such as for example, galvanostatic charge-discharge, cyclic voltammetry, AC impedance techniques, or the like.

Other useful materials and methods with the present invention can be found in the following articles and/or publications, each of which is incorporated herein by reference in its entirety: Rolland, J. P., Maynor, B. W., Euliss, L. E., Exner, A. E., Denison, G. M., DeSimone, J. M. “Direct Fabrication and Harvesting of Monodisperse, Shape-Specific Nanobiomaterials” J. Am. Chem. Soc. 2005, 127, 10096-10100; Balazs, A. C., Emrick, T., Russell, T. P. “Nanoparticle Polymer Composites: Where Two Small Worlds Meet” Science, 2006, 314, 1107-1110; Krishnamoorti, R. “Strategies for Dispersing Nanoparticles in Polymers” MRS Bulletin, 2007, 32, 341-346; Vaia, R. A., Maguire, J. F. “Polymer Nanocomposites with Prescribed Morphology: Going beyond Nanoparticle-Filled Polymers” Chem. Mater. 2007, 19, 2736-2751; Popielarz, R., Chiang, C. K. “Polymer composites with the dielectric constant comparable to that of barium titanate ceramics” Mat. Sci. Eng. B 2007, 139, 48-54; Brosseau, C., Beroual, A., Boudida, A. “How do shape anisotropy and spatial orientation of the constituents affect the permittivity of dielectric heterostructures?” J. Appl. Phys. 2000, 12, 7278-7288; Calame, J. P. “Finite difference simulations of permittivity and electric field statistics in ceramic-polymer composites for capacitor applications” J. Appl. Phys. 2006, 99, 084101; Hirano, S., Shimada, S., Kuwabara, M. “Fabrication and optical reflection behavior of a two-dimensional barium titanate ceramic photonic crystal” Appl. Phys. A 2005, 80, 783-786; Bhuiyan, M. S., Paranthanman, M., Salama, K. “Solution-derived textured oxide thin films—a review” Superconductor Science and Technology 2006, 19, R1-R21; Choi, H., Hwang, S. “Sol-gel-derived magnesium oxide precursor for thin-film fabrication” J. Mater. Res. 2000, 15, 842-845; and Fu, X., Song, Z., Wu, G., Huang, J., Duo, X., Lin, C. “Preparation and Characterization of MgO Thin Films by a Novel Sol-Gel Method” J. Sol-Gel Sci. Technol. 1999, 16, 277-281.

### EXAMPLES

### Example I

### Perfluoropolyether-Barium Titanate (PFPE-BaTiO₃) composite

Step 1: Fabrication of scum-free BaTiO₃ particle array on magnesium oxide (MgO)

A BaTiO₃ sol was prepared as follows: barium acetate was dissolved in glacial acetic acid at 80 degrees C. to form a 40 wt % solution. Separately a 1:1 molar solution of titanium (IV) isopropoxide (equimolar amount to barium acetate) and acetylacetone was prepared. The two solutions were combined at approximately 50 degrees C., then cooled to room temperature while stirring constantly. The sol was diluted with 20 wt % 2-methoxyethanol, and filtered through a 0.45 micrometer PTFE syringe filter. Both polished single crystalline MgO substrates and sol-gel derived MgO thin films on silicon were used as substrates. The single crystalline MgO substrates were re-used multiple times, however over time they got damaged and needed to be discarded. A drop of the BaTiO₃ sol was placed on the MgO surface, and a PFPE mold (7 micrometers cylindrical features) was brought into contact. Pressure was applied using a vice. The vice was placed in a 110 degrees C. oven for 1 hour. The mold was removed leaving an array of 7 micrometers cylindrical xerogel particles on MgO. The array was then placed in a furnace at 700 degrees C. for 1 hour. The particle size decreased during the annealing process, resulting in a 3 micrometers cylindrical BaTiO₃ particle array.

Step 2: Fabrication of first composite layer

The PFPE precursor was spin-coated on the particle array (2000 rpm for 30 seconds). An expanded polytetrafluoroethylene (ePTFE) membrane was gently placed in the thin layer of liquid, and photocured in nitrogen. The composite layer was then gently peeled off the MgO.

Step 3: Adding multiple layers

Again, the PFPE precursor was spin-coated onto a particle array, then the first reinforced layer was placed on the thin layer of liquid, and a hand-held roller was used to ensure uniform coverage. The PFPE was photocured in N₂, then the film was removed. This was repeated to layer the film, as shown in FIG. 2.

### Example II

A BaTiO₃ sol was prepared as follows: barium acetate was dissolved in glacial acetic acid at 80 degrees C. to form a 40 wt % solution. Separately a 1:1 molar solution of titanium (IV) isopropoxide (equimolar amount to barium acetate) and acetylacetone was prepared. The two solutions were combined at approximately 50 degrees C., then cooled to room temperature while stirring constantly. The sol was diluted with 20 wt % 2-methoxyethanol, and filtered through a 0.45 micrometer PTFE syringe filter. A bulk sample of the sol was heated to form the xerogel (120 degrees C.), then calcined to form the ceramic. The crystal structure was determined by X-ray Diffraction.

Both polished single crystalline MgO substrates and sol-gel derived MgO thin films on silicon were used as substrates. While silicon is the preferred substrate for growing ceramic layers in industry, it was found that magnesium oxide is a more suitable substrate as it is lattice matched with many ferroelectric, superconducting and semiconducting materials. Additionally it has a high thermal/chemical stability and good electrical insulating properties. Due to the high cost of single crystalline MgO, we used the sol-gel approach to deposit oriented thin films of MgO on silicon.

A drop of the BaTiO₃ sol was placed on the MgO surface, and a PFPE mold (7 micrometer cylindrical features) was brought into contact. Pressure was applied using a vice. The vice was placed in a 110 degrees C. oven for 1 hour. The mold was removed leaving an array of 7 micrometer cylindrical xerogel particles on MgO. The array was then placed in a furnace at 700 degrees C. for 1 hour. The particle size decreased during the annealing process, resulting in a 3 micrometer cylindrical BaTiO₃ particle array.

The second step in the fabrication is the preparation of the first reinforced composite layer. The PFPE precursor was spin-coated on the particle array (2000 rpm for 30 seconds). An expanded polytetrafluoroethylene (ePTFE) membrane was gently placed in the thin layer of liquid, and photocured in nitrogen. The composite layer was then gently peeled off the MgO. To add additional layers, again, the PFPE precursor was spin-coated onto a particle array, then the first reinforced layer was placed on the thin layer of liquid, and a hand-held roller was used to ensure uniform coverage. The PFPE was photocured in N₂, then the film removed. This was repeated to layer the film. The result is a multilayered film with uniformly dispersed BaTiO₃ particles, as shown in FIG. 2.

1. A polymer composite, comprising:
a first polymer component; and
an additive encased in the first polymer component;
wherein the additive comprises a plurality of isolated particles wherein;
each particle of the plurality of particles has a substantially predetermined three dimensional shape; and
each particle of the plurality of particles is substantially oriented with respect to each other in a predetermined two dimensional array.

2. (canceled)

3. The polymer composite of claim 1, further comprising a second polymer component encasing a second additive, wherein the second polymer component is coupled with the first polymer component.

4. The polymer composite of claim 3, wherein the second polymer component is registered with the first polymer component to position the additive in the second polymer component in a predetermined orientation with respect to the additive in the first polymer component.

5. (canceled)

6. The polymer composite of claim 3, wherein the second polymer component is registered with the first polymer component to position the additive in the second polymer component with respect to the additive in the first polymer component to manipulate light.

7. The polymer composite of claim 1, wherein the first polymer component comprises a thickness of less than about 20 micrometers.

8-10. (canceled)

11. The polymer composite of claim 1, wherein the substantially predetermined shape comprises a particle having a broadest cross-sectional dimension less than about 5 micrometers.

12. The polymer composite of claim 1, wherein the substantially predetermined shape comprises a particle having a broadest cross-sectional dimension less than about 1 micrometer.

13-18. (canceled)

19. The polymer composite of claim 3, wherein the second additive comprises a different material from a material of the additive of the first polymer component.

20. The polymer composite of claim 1, wherein the polymer of the first polymer component comprises a perfluoropolyether.

21-22. (canceled)

23. The polymer composite of claim 1, further comprising a volume fraction of additive of between about 0.1 percent and about 75 percent.

24-28. (canceled)

29. The polymer composite of claim 1, wherein the polymer of the first polymer component encasing the additive is configured and dimensioned as a sensor, a biomimetic, an actuator, a waveguide, a photonic band gap device, an optical device, or an energy storage device.

30. The polymer composite of claim 1, wherein the additive includes a ceramic material.

31. The polymer composite of claim 1, wherein the additive includes BaTiO₃.

32. (canceled)

33. An energy storage device, comprising:
a first component comprising a polymer having a dielectric strength greater than about 5 kV/mm and encasing an additive;
wherein the additive comprises a plurality of isolated particles wherein;
each particle of the plurality of particles has a substantially predetermined three dimensional shape; and
each particle of the plurality of particles is substantially oriented with respect to each other in a predetermined two dimensional array.

34-38. (canceled)

39. A method of making a polymer composite, comprising:
molding isolated particles in cavities of a low surface energy polymeric material;
harvesting the isolated particles from the cavities of the low surface energy polymeric material into an array of isolated particles; and
filling space between the harvested isolated particles with a polymer material such that the isolated particles are encased within the polymer material.

40. The method of claim 39, wherein the low surface energy polymeric material comprises perfluoropolyether.

41. (canceled)

42. The method of claim 39, wherein the polymer material encasing the isolated particle comprises a perfluoropolyether.

43. (canceled)

44. The method of claim 39, further comprising, after the filing, coupling a second layer of polymer material encasing harvested isolated particles to the polymer material encasing the harvested isolated particles.

45-47. (canceled)

48. The energy storage device of claim 14, further comprising a second component coupled with the first component, wherein the second component comprises a polymer having a dielectric strength greater than about 5 kV/mm and encasing an additive;
wherein the additive comprises a plurality of isolated particles wherein;
each particle of the plurality of particles has a substantially predetermined three dimensional shape; and
each particle of the plurality of particles is substantially oriented with respect to each other in a predetermined two dimensional array.

49. The energy storage device of claim 15, wherein the first component and the second component have different dielectric strengths.
